(19) United States
(12) Patent Application Publication
(10) Pub. No.: US 2023/0341508 A1
(43) Pub. Date: Oct. 26, 2023

(54) SONIC POLE POSITION TRIANGULATION IN A LIGHTING SYSTEM

(71) Applicant: UBICQUIA IQ LLC, Fort Lauderdale, FL (US)

(72) Inventor: MORNÉ NESER, MONTRÉAL (CA)

(21) Appl. No.: 18/209,460

(22) Filed: Jun. 13, 2023

Related U.S. Application Data
(63) Continuation of application No. 16/959,121, filed on Jun. 29, 2020.
(60) Provisional application No. 62/611,843, filed on Dec. 29, 2017.

(51) Int. Cl. G01S 5/22; G01S 5/30

(52) U.S. Cl. CPC G01S 5/22; G01S 5/30; H04W 4/029

(57) ABSTRACT

Provided is a method and system that includes a lighting fixture having a sensor unit and a processor and that includes an audio detection device which includes a microphone connected with the processor to detect audio signal adjacent to the lighting fixture, a time measuring device for recording a time measurement associated with the audio signal, a pair of mobile devices that each include a sonic wave generator for generating sonic wave signal in a direction of the microphone, and a distance calculation unit to calculate a distance between the sonic wave signal and the audio signal based on a time-stamp of the sonic wave signal and the audio signal, to determine a sonic pole position triangulation indicative of a location of the lighting fixture.

### CROSS-REFERENCE TO RELATED APPLICATIONS

The present application is a continuation of U.S. application Ser. No. 16/959,121, which was filed on Jun. 29, 2020, and is incorporated herein by this reference in its entirety. application Ser. No. 16/959,121 is a national stage entry under 35 U.S.C. § 371(c) of International Application No. PCT/US2018/067815, which was filed on Dec. 28, 2018, and is incorporated herein by this reference in its entirety. International Application No. PCT/US2018/067815 claims priority under 35 U.S.C. § 119(e) upon, and the benefit of, U.S. Provisional Application No. 62/611,843, which was filed on Dec. 29, 2017, and is incorporated herein by reference in its entirety.

### TECHNICAL FIELD

The present invention relates generally to a system and method for performing sonic pole position triangulation to detect a location. In particular, the present invention relates to performing sonic pole position triangulation to detect a location of specific lighting fixtures based on sound associated with a streetlight system.

### BACKGROUND

Many newer streetlight systems employ technological advancements and smart technology to perform additional functions beyond providing appropriate street lighting. For example, these newer streetlight systems can also monitor traffic low, pedestrian traffic, and parking conditions, as well as perform other functions via internal camera and sensor technology. These newer systems, however, offer few advancements in the use of sonic technology.

For example, even the newer or technologically advanced systems are unable to timely locate specific lighting fixtures using sonic pole position triangulation to detect locations of car accidents, gunfire, and other audio sounds. The deployment of such systems could eliminate undesirable delays when users approach areas of concern.

### SUMMARY

Given the aforementioned deficiencies, a need exists for systems and methods capable of timely providing location information for lighting fixtures, for example in real-time, to eliminate undesirable delays in approaching the areas of concern.

Embodiments of the present invention provide technology and methods to measure travel time associated with audio signals from known lighting fixture locations to calculate position of the poles. These techniques enable the use of multiple sources to identify the location of fixtures through triangulation, or a single source. This identification can be based upon sonic data (e.g., ultrasonic data) to provide information associated with specific areas of concern to pedestrians or drivers.

Embodiments of the present invention provide a system including a lighting fixture. The lighting fixture comprises a sensor unit including a processor and a microphone connected with the processor and configured to detect audio signal adjacent to the lighting fixture. The lighting fixture also includes a time measuring device connecting with the processor for recording a time measurement associated with the audio signal, and a pair of mobile devices each comprising a sonic wave generator for generating sonic wave signal in the direction of the microphone. A distance calculation unit is provided to calculate a distance between the sonic wave signal and the audio signal based on a time-stamp of the sonic wave signal and the audio signal, to determine a sonic pole position triangulation indicative of a location of the lighting fixture.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### BRIEF DESCRIPTION OF THE DRAWINGS

FIG. 1 is a schematic illustrating a system performing sonic pole position triangulation to determine location of a lighting fixture in accordance with one or more embodiments of the present invention.

FIG. 2 is a block diagram illustrating the system as shown in FIG. 1 that can be implemented within one or more embodiments of the present invention.

FIG. 3 is a block diagram illustrating an example of the distance calculation unit of the system as shown in FIG. 2 that can be implemented within one or more embodiments of the present invention.

FIG. 4 is a flow diagram illustrating a method for automatically identifying video analytics to be performed that can be implemented within one or more embodiments of the present invention.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### DETAILED DESCRIPTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components.

In other instances, well-known components, apparatuses, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

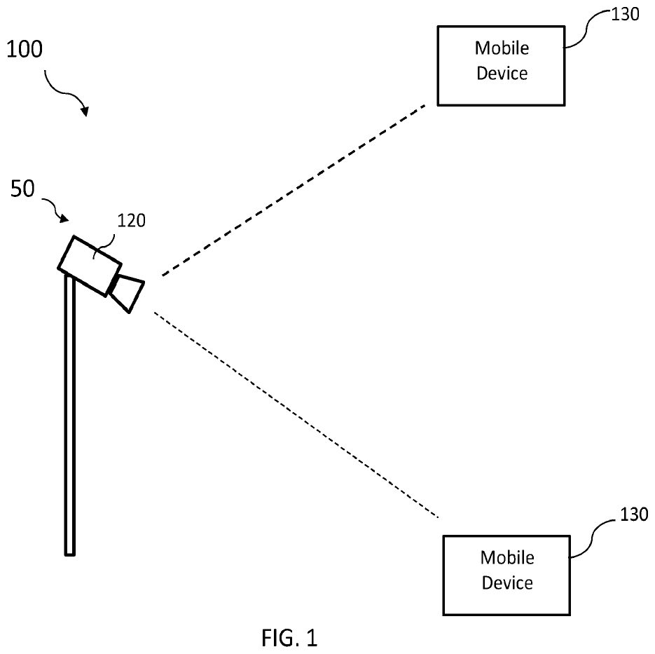

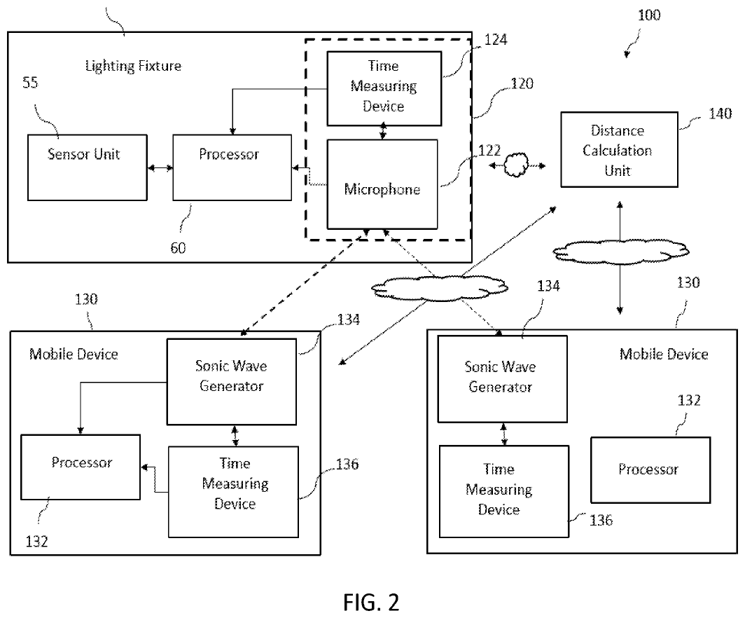

As noted above, the embodiments provide a method and system for performing sonic pole position triangulation to determine location of a lighting fixture adjacent to a detected audio signal representative, for example, of a car accident, gunfire, etc. This method can be performed within lighting fixtures of a streetlight system over a communication network between the lighting fixture and an external system (e.g., a centralized distance calculation unit within a remote server). The communication network can be a network such as global positioning system (GPS), Wi-Fi, Internet, Bluetooth, 802.11, 802.15 and cellular networks. The embodiments of the present invention will now be discussed with reference to FIGS. 1 and 2.

FIG. 1 is a schematic illustrating an exemplary system 100 for performing sonic pole position triangulation to determine location of a lighting fixture in accordance with the embodiments. The system 100 can be implemented within existing streetlight systems. As shown in FIG. 1, the system 100 includes an audio detection device 120 and a plurality of mobile devices 130 adjacent to the audio detection device 120. The audio detection device 120 is located within a lighting fixture 50 including a sensor unit 55 and a processor 60 connected thereto. The sensor unit 55 includes various sensors and network capabilities.

The audio detection device 120 includes a microphone 122 connected with the processor 60 and configured to detect audio signals (e.g., sounds nearby), a time measuring device 124 connected with the processor 60 for recording a time measurement associated with the audio signals detected. The audio detection device 120 can be implemented within the lighting fixture 50 as a separate device adjacent thereto. Audio detection device 120 measures the travel time of audio signals from known locations to the lighting fixture 50, to calculate the position of the poles. Although the audio signal can be within any one of several different frequency bands, in one of more embodiments, the signal is within the ultrasonic frequency band.

When an audio signal is detected by the audio detection device 120, the time measuring device 124 time-stamps the detected audio signal. The measured time is processed by the processor 60. The difference between time-stamps of when the audio signal is generated, and when it is measured at the lighting fixture 50, can be used to calculate the distance from the source of the audio signal.

The system 100 also includes a plurality of mobile devices 130 located within close proximity to the audio detection device 120 and the lighting fixture 50.

The audio detection device 120 and the lighting fixture 50 can communicate wirelessly with the mobile devices 130. Specifically, the audio detection device 120 and the two mobile devices 130 are disposed in a triangulation position such that the location of the microphone 122 is at an intersection of virtual spheres of calculated distances (as indicated by the arrows) from the sonic wave generators 134 of the mobile devices 122.

Each mobile device 130 includes a processor 132, the sonic wave generator 134, and a time measuring device 136. According to an embodiment, a predefined geo-location of the sonic wave generator 134 is determined using GPS or another surveying or beacon system.

The sonic wave generator 134 and the time measuring device 136 are connected to the processor 132. When an audio signal is detected by the microphone 122 at the lighting fixture 50, the sonic wave generator 134 generates a sonic wave signal in the direction of the microphone 122. The timing of the generation of the sonic wave signal is measured by the time measuring device 136.

The system 100 also includes a distance calculation unit 140 to determine a distance between the sonic wave generator 134 and the microphone 122. This determination is based on differences between the time-stamp of the sonic wave signal and that of the audio signal. This difference is used to determine a sonic pole position triangulation indicative of a location of the lighting fixture 50.

The communication between the sonic wave generator 134 and the distance calculation unit 140 can be a wireless or wired communication channel. The location and time-stamp data of the sonic wave generator 134 and the audio detection device 120 can be transferred to the distance calculation unit 140 in real-time for analysis.

According to embodiments of the present invention, the cameras employed at the lighting fixtures can also be used to capture images corresponding to the time-stamped audio signal detected by the audio detection device 120 at the lighting fixture 50. This imaging information can be useful in observing circumstances associated with the detected audio signal. For example, images of a car accident in progress can be captured based upon detecting audio signals associated with the car accident.

According to an embodiment of the present invention, the distance calculation unit 140 can reside in a remote server within a cloud environment. Alternatively, the distance calculation unit 140 can be integrated within the sonic wave generator 134 within at least one of the mobile devices 130.

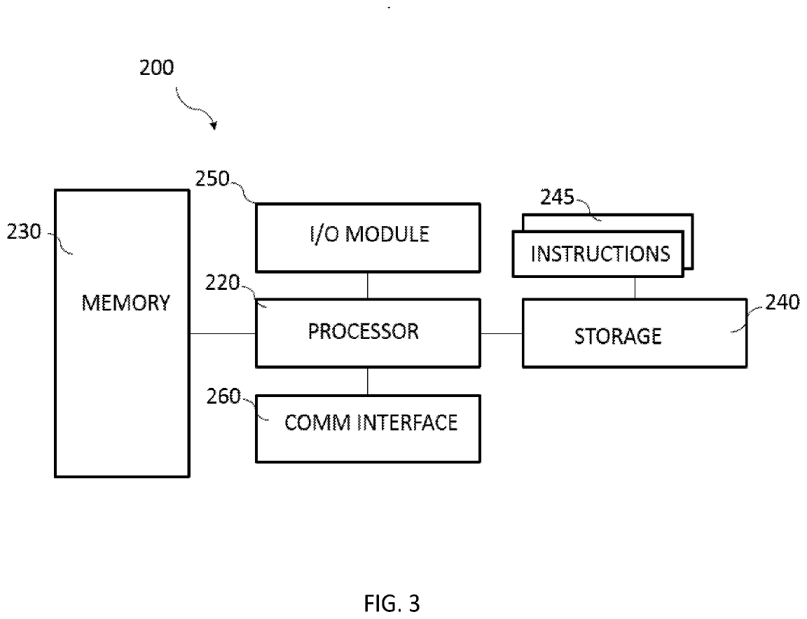

FIG. 3 is a more detailed illustration of an example distance calculation unit 140 according to the embodiments. As depicted in FIG. 3, the distance calculation unit 140 can be a computing device 200 including a processor 220 with a specific structure. The specific structure is imparted to the processor 220 by instructions 245 stored in an internal memory 230 included therein. The structure can also be imparted by instructions 240 that can be fetched by the processor 220 from a storage medium 240. The storage medium 240 may be co-located with the system 200 as shown, or it may be located elsewhere and be communicatively coupled to the system 200.

The system 200 may include one or more hardware and/or software components configured to fetch, decode, execute, store, analyze, distribute, evaluate, diagnose, and/or categorize information. Furthermore, the system 200 can include an (input/output) I/O module 250 that can be configured to interface with the mobile devices 130 and the audio detection device 120 and sensor 55, and processor 60 of the lighting fixture 50. The system 200 is calibrated during installation so that sensor detection corresponds to a known physical location (e.g., geo-location on a map).

The processor 220 may include one or more processing devices or cores (not shown). In some embodiments, the processor 220 can be a plurality of processors, each having either one or more cores. The processor 220 can be configured to execute instructions 245 fetched from the memory 230, or the instructions may be fetched from storage medium 240, or from a remote device connected to computing device via a communication interface 260.

Furthermore, without loss of generality, the storage medium 240 and/or the memory 230 may include a volatile or non-volatile, magnetic, semiconductor, tape, optical, removable, non-removable, read-only, random-access, or any type of non-transitory computer-readable computer medium. The storage medium 240 and/or the memory 230 may include programs and/or other information that may be used by the processor 220.

Moreover, the storage medium 240 may be configured to log data processed, recorded, or collected during the operation of the computing device 200. For example, the storage medium 240 may store historical patterns of the data including distance data between the audio detection device 120 and the sonic wave generators 134 at the mobile devices 130. Image data received from the camera at the lighting fixture 50 can be stored along with historical patterns. The data may be time-stamped, location-stamped, cataloged, indexed, or organized in a variety of ways consistent with data storage practice.

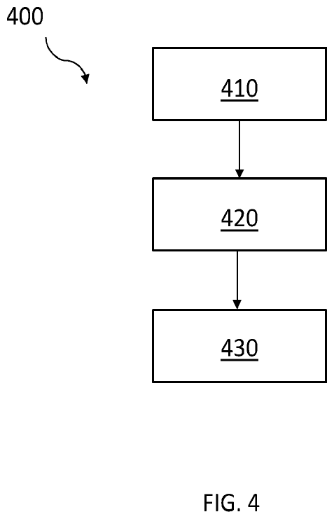

FIG. 4 is a flow diagram illustrating an exemplary method 400 performing sonic pole position triangulation to determine a location of a lighting fixture according to the embodiments. The method 400 can be implemented within various types of systems, for example, traffic or pedestrian systems, and parking systems.

The method 400 begins at operation 410 where an audio signal is generated, and the audio signal is detected by a microphone at the lighting fixture and time-stamped by a time measuring device. The process continues at operation 420, where a sonic wave signal is generated at a sonic wave generator within a pair of mobile devices within close proximity to the lighting fixture. The sonic wave signal is time-stamped and processed at each mobile device.

From operation 420, the process continues to operation 430 where a distance calculation unit calculates a physical distance between the lighting fixture and the mobile devices and the distance between the time-stamp of the detected audio signal and that of the sonic wave signals generated to thereby perform sonic pole position triangulation to determine a specific location of the lighting fixture.

Embodiments of the present invention provide the advantages of locating specific lighting fixtures using sonic pole position triangulation to detect locations of car accidents, gunfire, and other audio sounds. Thus, the system can provide location information of lighting fixtures in real-time.

This written description uses examples to disclose the invention including the best mode, and also to enable any person skilled in the art to practice the invention, including making and using any devices or apparatuses and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a lighting fixture mounted on a streetlight pole, the lighting fixture including:
a processor; and
an audio detection circuit that includes:
a microphone communicatively coupled to the processor, the microphone arranged to detect audio signals from known locations proximate the lighting fixture, and
a time measuring device arranged to record time measurement data associated with each detected audio signal;
a plurality of mobile devices, each of the plurality of mobile devices including a sonic wave generator arranged to generate respective sonic wave signals, at least a portion of each sonic wave signal arranged to propagate in a direction of the lighting fixture; and
a distance calculation unit arranged to (a) calculate physical distances between the mobile devices and the lighting fixture based on time differences between time-stamps of sonic wave signals transmitted by the sonic wave generators of the mobile devices and the time measurement data of the audio signals detected by the microphone, and (b) determine a location of the lighting fixture based on triangulation using the calculated distances.

2. The system of claim 1, wherein the audio detection circuit is integrally combined within the lighting fixture.

3. The system of claim 1, wherein the time measuring device of the audio detection circuit is configured to measure travel times of the detected audio signals.

4. The system of claim 1, wherein the audio signals are ultrasonic.

5. The system of claim 1, wherein the audio detection circuit and the plurality of mobile devices are disposed in a triangular relation and wherein the microphone is located at an intersection of virtual spheres of calculated distances from the plurality of mobile devices.

6. The system of claim 5, wherein each mobile device further comprises:
a processor to initiate generation of sonic wave signals; and
a time measuring device to record time measurements of the sonic wave signals.

7. The system of claim 1, wherein a predefined geo-location of each sonic wave generator is determined using a global positioning system.

8. The system of claim 1, wherein the distance calculation unit communicates with the audio detection circuit and the mobile devices via a cloud environment.

9. The system of claim 1, wherein the distance calculation unit.

10. A method for performing sonic pole position triangulation to determine a location of a lighting fixture, the method comprising:
generating, by each of a plurality of mobile devices proximate the lighting fixture detecting, a respective sonic wave signal, at least a portion of each sonic wave signal propagated in a direction of the lighting fixture;
detecting, by a microphone positioned at the lighting fixture, an audio signal;
recording, by a time measuring device, a time at which the audio signal was detected by the microphone;
calculating physical distances between the lighting fixture and the mobile devices based on time differences between time-stamps of sonic wave signals transmitted by the mobile devices and the time at which the audio signal was detected by the microphone, and
determining a location of the lighting fixture based on triangulation using the calculated distances.

11. The method of claim 10, further comprising:
measuring a travel time of the audio signal from a known location to the lighting fixture.

12. The method of claim 10, wherein the audio signal is ultrasonic.

13. The method of claim 10, wherein the lighting fixture and the plurality of mobile devices are disposed in a triangular relation and wherein the microphone is located at an intersection of virtual spheres of calculated distances from the plurality of mobile devices.

14. The method of claim 10, further comprising:
recording, by each mobile device, a time measurement; and
embedding a representation of the time measurement in the sonic wave signal transmitted by the mobile device.

15. The method of claim 10, further comprising:
pre-defining a geo-location of each mobile device using a global positioning system.

16. A lighting fixture location system comprising:
a processor;
an audio detection circuit that includes:
a microphone communicatively coupled to the processor, the microphone arranged to detect audio signals from known locations proximate a lighting fixture, and
a time measuring device arranged to record time measurement data associated with each detected audio signal; and
a distance calculation unit arranged to (a) calculate physical distances between a plurality of mobile devices and the lighting fixture based on time differences between time-stamps of sonic wave signals transmitted by the mobile devices and the time measurement data of the audio signals detected by the microphone, and (b) determine a location of the lighting fixture based on triangulation using the calculated distances.

17. The system of claim 16, wherein the distance calculation unit is integrated within the lighting fixture.
